(19) United States
(12) Patent Application Publication
(10) Pub. No.: US 2018/0044911 A1
(43) Pub. Date: Feb. 15, 2018

(54) REUSABLE DEVICE FOR PROTECTING AGAINST WATER CONDUCTION

(71) Applicant: Roland WOLF, Stuttgart (DE)

(72) Inventor: Roland WOLF, Stuttgart (DE)

(21) Appl. No.: 15/549,670

(22) PCT Filed: Feb. 10, 2016
(86) PCT No.: PCT/EP2016/052784

§ 371 Date: Aug. 9, 2017

(30) Foreign Application Priority Data
Feb. 11, 2015 (EP) 15154700.7

(51) Int. Cl. E04B 1/68; F16L 5/04

(52) U.S. Cl. CPC E04B 1/6813; F16L 5/04

(57) ABSTRACT

The application comprises a device for protecting against water ingress and fire penetration into interspaces and into cavities through expansion joints in structures, cable ducts and cable lead-throughs which are occupied by cables and/or pipes, and, depending on the application, serves as a fire protection or leakage protection device in landfills, tank systems and transport and/or safety containers in the sea sector. The device comprises a flat-tube cushion which is fixed in terms of length and width and which is equipped on the outer sides with a swellable nonwoven sealing strip. In the interior, the leakage or protective flat-tube cushion is provided with at least one swellable nonwoven sealing strip which has high-tensile-strength closures on the longitudinal side and the transverse side and is filled or evacuated via at least one plastic-coated metal compressed-air valve with a valve extension, and, depending on the application, can be equipped with a radio monitoring or control system.

The invention relates to a reusable device for protection against water conduction in ducts and subsystems as defined by the preamble to claim 1.

In a first patent application, published as EP 1686 670 A1 on Aug. 2, 2006, a device for sealing off interstices and for lifting or securing workpieces is described.

In a second patent application, published on Dec. 19, 2007 as EP 1867 904 A1, a device for gastight and high-pressure water-tight closing of hollow spaces, between masonry perforations, and between cable ducts and for sealing off interstices in movable walls in accordance with the preamble to claim 1 is described. The sealing cushion described there is equivalent to EP 1686 670 A1, in which in addition, a further development for masonry lead-throughs is described. In it, a double BigBag with firewall strip, powder, gas or liquid filling in the BigBag interior, two tire valves, and sealing modules are also described. The production process employed is welding.

A disadvantage of the concepts described is that they are problematic for expansion joints in subsections and/or pipes and/or cables and for ducts and masonry lead-throughs. Sealing between multiply occupied cables and/or pipes is not contemplated. Outfitting for water conduction protection in the event of leakage of dangerous water mixture substances with use in tank systems is either possible only with difficulty or not possible at all.

From JP 2009 118548 A, a sealing structure for an opening in a duct within which many cables are drawn is known, with a water-expansion striplike element that can be compressed in the direction of its thickness.

From JP 2002 194824 A, a water sealing tool is known, having an outer region of a rubber material or resin material and having a water-swelling material in the outer cladding.

The object of the invention is from composite film to create a reusable protection device against water conduction of the type recited in the preamble to claim 1: The reusable protection device with interaction in expansion joints in subsections and/or of ducts occupied by pipes and/or cables and masonry lead-throughs is intended to be usable as water conduction protection in the event of leakage from dangerous water mixture substances in tank systems, in order to seal off storage and transport containers, landfills, and/or in the sea.

The sealing action is achieved by means of two functions. The first sealing function has the sealing cushion with a valve, which under pressure presses the swellable nonwoven sealing strip and/or sealing stars into the interstices. The second sealing function does not come into effect until water or chemical mixtures pH2, pH12 and/or ca. 80% gasoline, diesel, kerosene or paraffin mixture activates the swellable nonwoven. Upon the ingress of water, the polymer embedded in the PP nonwoven swells at the noncompressed sealing points and by its extremely dense, gel-like sealing layer embedded in the PP nonwoven creates the protection against water conduction during the ingress of water. After the gel layer has dried, an overpressure at heat of ≧0.3 bar can be avoided by the swellable nonwoven; upon a new ingress of water, the polymer reliably swells up again.

The protection device against water conduction with interaction in subsections is intended to be universally suitable for a broad spectrum of application and, by means of a high impact strength and high bursting pressure, chemical, and water pressure resistance with a low intrinsic weight of from 850 g/m², to meet the requirement of mechanically exerting an effective elastic area compression and/or water barrier pressure. Furthermore, in the first function, with the inflatable device coated with swellable nonwoven on the outside up to 50 m in length, expansion joints in width of 2 cm to 40 cm are to be reliably and economically sealed off in a record time of approximately 10 min/m.

In the second function, the intention is that damage to persons and property resulting from water penetration and conduction leading to icicle formation and slippery icy surfaces should be reliably avoided.

With the vacuum protection device with internal swellable nonwoven sealing strips in sizes of up to 10 m wide and up to 100 m long that seal off against water conduction, it is possible for landfills and tank systems to be reliably sealed off from radioactive and/or explosive substances, dangerous pollutants, or leaks caused by damage. The protection device, which can be modified depending on the particular application, is intended by reason of its low surface weight of 850, 1300 or 1800 g/m², its high flexibility, high impact strength at ca. 40 N/cm² and high burst pressure resistance at ca. 9 bar, and depending on the need for leak point monitoring, to be equipped with a 2.4 GHz radio monitoring system or equivalent control system. With monitoring of individual basic elements, operation-dictated settings and/or leak points from chemical mixtures pH2, pH12, gasoline, diesel, kerosene and paraffin oil can be analyzed, along with temperatures, under alternating stress.

The best known expansion joint sealing systems, namely
joint strips of rubber or bitumen,
sheet-metal joints,
swellable joint inlays of rubber,
injection hose,
injection groutings,
PUR gel injection groutings
   have the familiar disadvantages that the seals under operating conditions are not resistance to settling, shearing, and expansions in the temperature range from −30° C. to +60° C.

A further disadvantage of the injection groutings is a very high expense for labor for injection bores, which have to be made before the injection grouting, and as a result the economy of the system is greatly impaired.

The following descriptions show the advantageous, final modifications of the aforementioned basic component, in accordance with the respective field of application.

When swellable nonwoven-sheathed PE or equivalent round cords sold by the meter are used, penetration of seeping water can be avoided in expansion joints. With the swellable nonwoven-sheathed, flexible fire protection strips in combination with the swellable nonwoven-coated cushions with a valve, an absolute waterproof and fireproof seal is achieved in cable infeed ducts and lead-throughs and/or expansion joints occupied with cables and/or pipes in two functions. The first sealing function has the sealing cushion with a valve that protects against water pressing against it; the second sealing function that protects against fire penetration is achieved by collapsing the cushion with the valve in the event of heat action at a temperature of >100° C. with ensuing activation of the flexible fire protection strips.

In use as a water blocking protection device for water-tight closure of expansion joints and/or movement joints, the air-fillable sealing system (valve) is surrounded, preferably over its entire surface, by a water-swelling swellable nonwoven sealing strip in order to achieve a complete water barrier toward the joint flanks. The flat-tube cushion, for a uniform and/or varying joint width depending on type, such as 2 cm to 8 cm, 2 cm to 17 cm, or 2 cm to 300 cm, is placed longitudinally via joint offset locations, curves and/or corners and secured until pressure filling with PE (or equivalent) round cord portions.

Filling the flat-tube cushion is done via a metal valve, which is connected to an extension welded into the flat-tube cushion. When the flat-tube cushion is pumped up with air or a liquid, the swellable nonwoven sealing strips are pressed into the interstices of joint offset locations. It is easily possible to remove the reusable devices by evacuation using a vacuum pump or by removing the valve insert.

For sealing off expansion joints in lengths of >23 m, a second and further sealing cushion is inserted approximately 0.25 m to 1 m into the expansion joint in coincidence with the first sealing cushion, so that tightness at the overlap is achieved.

The filling of the flat-tube cushions is possible by first filling the longest cushion and next the shortest cushion up to the rated fill pressure.

For sealing off expansion joints in arched bridges, sealing cushions in lengths of the arch radius are used. All the sealing cushions are inserted approximately 0.25 m into the expansion joints, in each case in coincident fashion at the ends, and are secured until pressure filling by a PE round cord.

For sealing off interstices of 50 mm to 250 mm in diameter, for instance in the case of multiply occupied ducts or building inlets, and inside diameters of ≦150 mm, a swellable nonwoven sealing star is inserted between the two, three or four cables and/or pipes. By being pumped up with air, depending on the field of application, a sealing device with interaction is achieved, so that cable protection tubes can escape the overpressure (air expansion from heat in plastic tube) and from the end of the pipe, a water pressure tightness up to 5 m for a water column of −0.5 bar is attained.

For sealing off against pressing water and fire penetration in ducts, building inlets and lead-throughs occupied by cables and/or pipes, the interstices downstream of the water protection built in with the sealing cushion (valve) are filled with swellable nonwoven-sheathed, flexible fire protection strips. Security against fire penetration is achieved by collapsing the cushion with the valve at a heat action of >100° C. and by activation of the fire protection strips by foaming.

When the protection devices are used against water conduction in leakages before and/or after damages, or for protection against pollutant substances or water ingress in storage and/or transport containers, the vacuum-evacuated sealing cushion (valve) is enclosed over its full surface, in accordance with a modification corresponding to the applicable field of use, by at least one ply of water-swelling swellable nonwoven, in order to achieve complete sealing.

The water mixture protection devices, as base profile bodies, are in one modification intended as endless goods sold by the meter, which are simply lined up with one another and/or placed one above the other by means of special shaping and/or machining along and attached with appropriate mountings; this is desired for the sake of reuse or when the sealing cushions (valve) permanently joined together in continuous gas welding in such a way that pressure changes can be located by a 2.4 GHz radio monitoring system to which a valve is attached.

The water protection device in a further modification for protection against water ingress in storage, transport and/or special component containers, which depending on the application comprise one or more base profile bodies cohesively joined together in a mat by suitable mounts by means of ropes. One can also imagine that the joint flank is attached by means of nails, screws, magnetic plates, or with a self-adhesive mass of butyl rubber or modified bitumen on the underside for the sake of quick fastening.

The invention will now be described in further detail in terms of exemplary embodiments. Shown are:

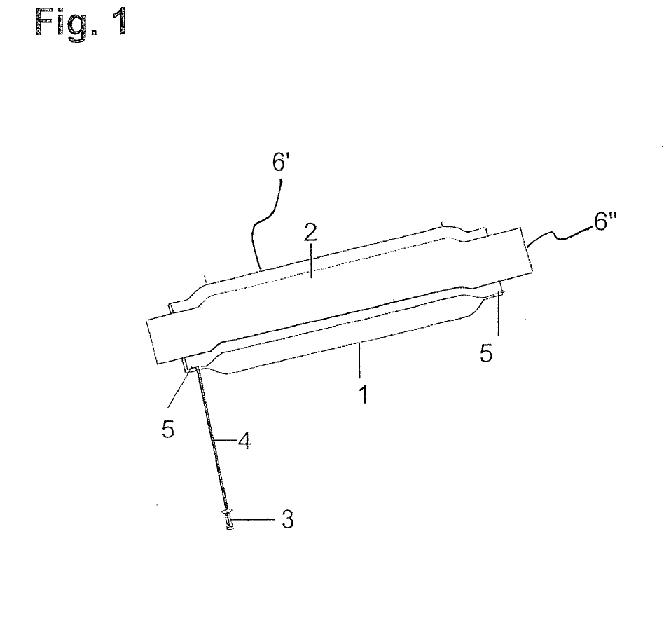

FIG. 1 a perspective view of a reusable protection device against water conduction as a sealing cushion with a tire valve for filling and evacuation in widths of 100 mm to 450 mm and lengths of 150 mm to 23 m, which in the continuous gas welding and hot-sealing welding process is welded all the way around with a 9 bar burst-pressure-resistant aluminum composite foil and tire valve and sheathed with swellable nonwoven sealing strip;

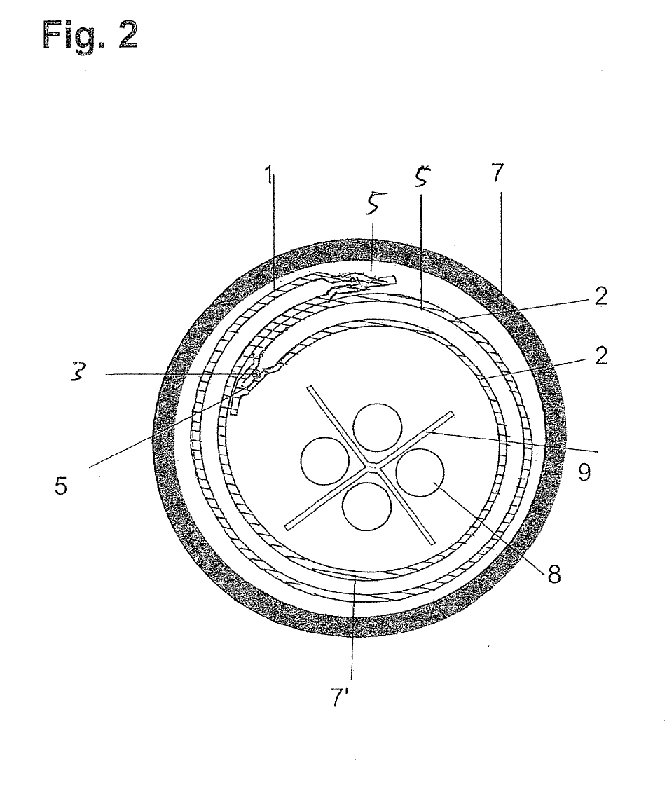

FIG. 2 a cross section of a protection device similar to the view in FIG. 1, which is provided for circular use in ducts occupied by cables and/or pipes and/or subsections for interstice sealing in ducts and/or pipes with interaction in the presence of heat and water, and a swellable nonwoven sealing star is introduced;

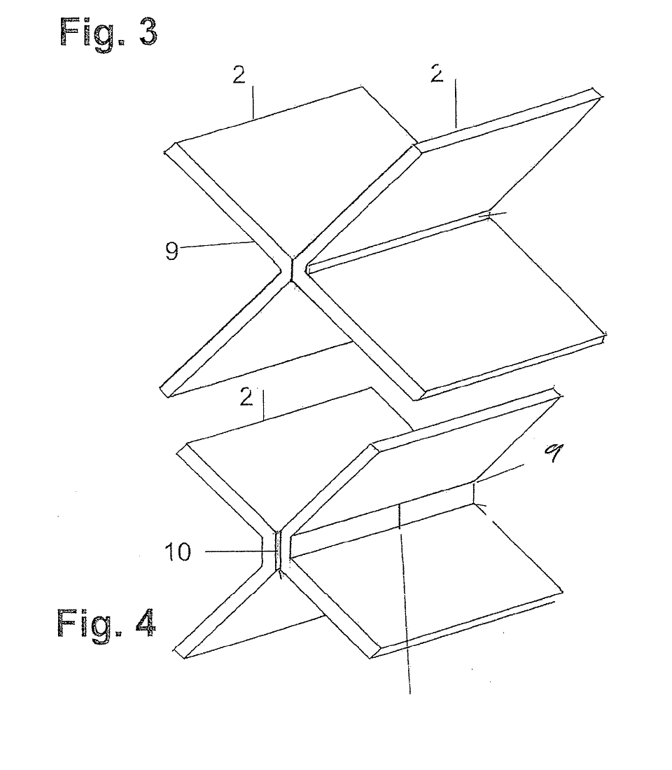

FIG. 3 a perspective view of the cable and/or pipe interstice seal shown in FIG. 2, produced from two swellable nonwoven sealing strips, placed one above the other, in the longitudinal direction as a swellable nonwoven sealing star with at least one longitudinal weld;

FIG. 4 a perspective view of the interstice seal shown in FIGS. 2 and 3 with interaction with two swellable nonwoven sealing strips placed one above the other, sewn or welded twice in the longitudinal direction and once in the transverse direction, as an insertable swellable nonwoven sealing star;

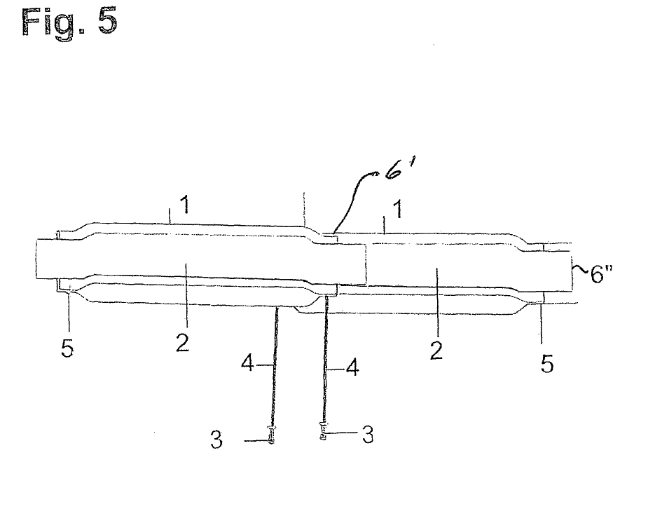

FIG. 5 a perspective view of a water protection device similar to FIG. 1 in subsections, bridges, buildings, and/or junctions with a curved joint course and/or expansion joints with lengths>23 m, in which a plurality of sealing cushions (valve) are introduced in offset fashion or lying one above the other;

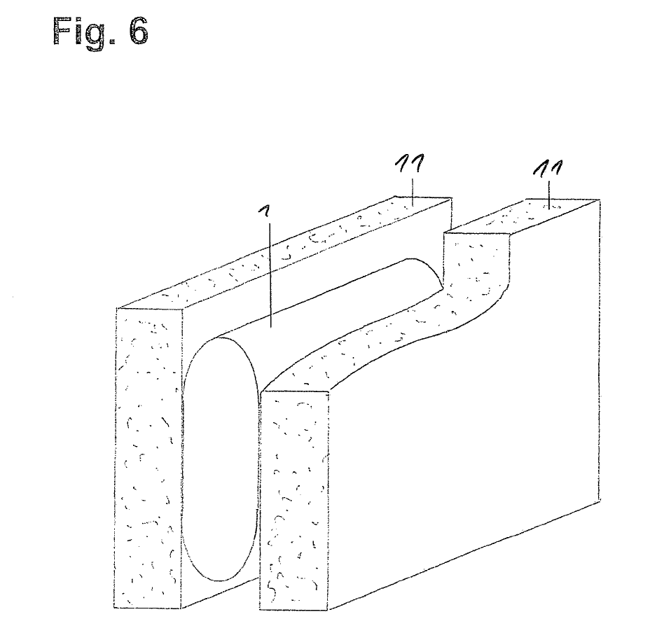

FIG. 6 a perspective view of a water protection device similar to FIGS. 1 and 5 in subsections, in which sealing cushions (valve) are introduced between the joint flanks;

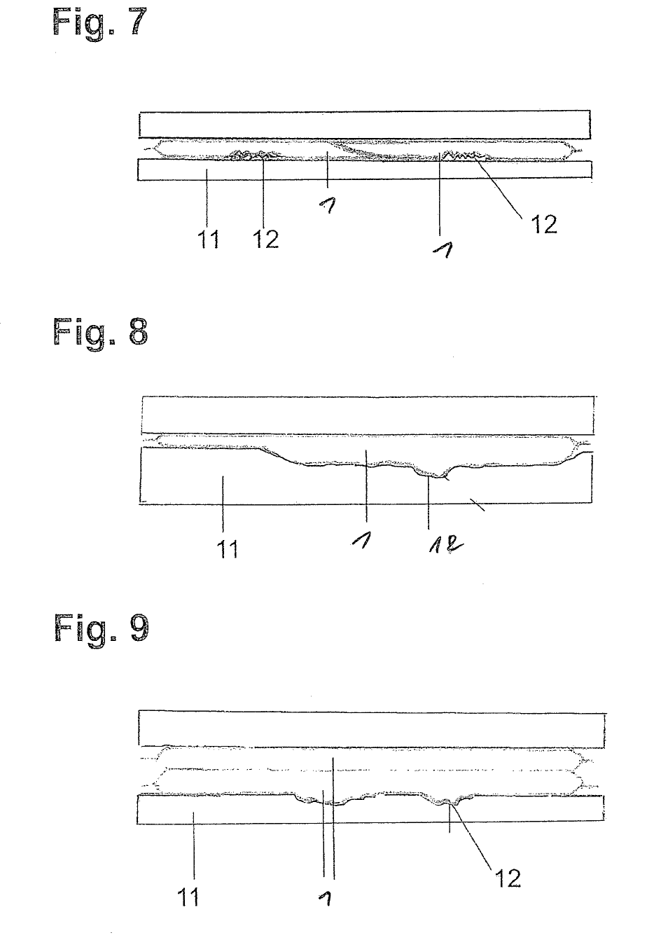

FIG. 7 a cross section of FIGS. 1, 5 and 6 embodied such that two sealing cushions (valve) are introduced, overlapped in the vicinity of joint offset locations, above left-over pieces of concrete;

FIG. 8 a cross section of FIGS. 1, 5, 6 and 7 embodied such that one or two sealing cushions (valve) are introduced in the vicinity of joint offset locations or broken-out places;

FIG. 9 a cross section of FIGS. 1, 5, 6, 7 and 8 embodied such that in subsections, two sealing cushions (valve) are introduced, lying one above the other in the expansion joints;

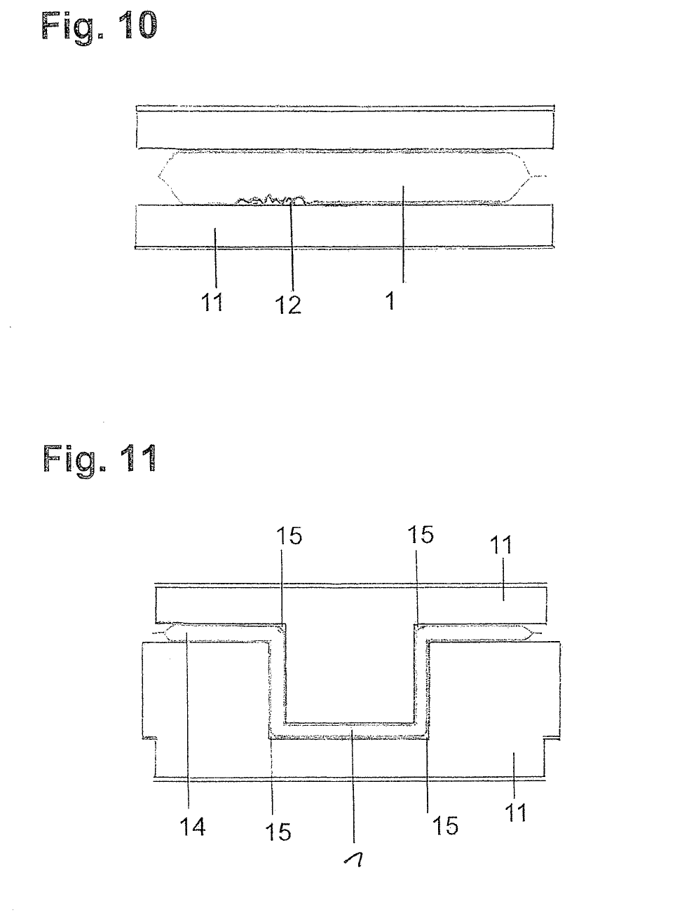

FIG. 10 a cross section of FIGS. 1, 5, 6, 7 and 9 embodied such that for a 300 mm expansion, a sealing cushion (valve) is introduced;

FIG. 11 a cross section of FIG. 1, embodied such that in subsections, the sealing cushion (valve) is introduced in one piece over corners;

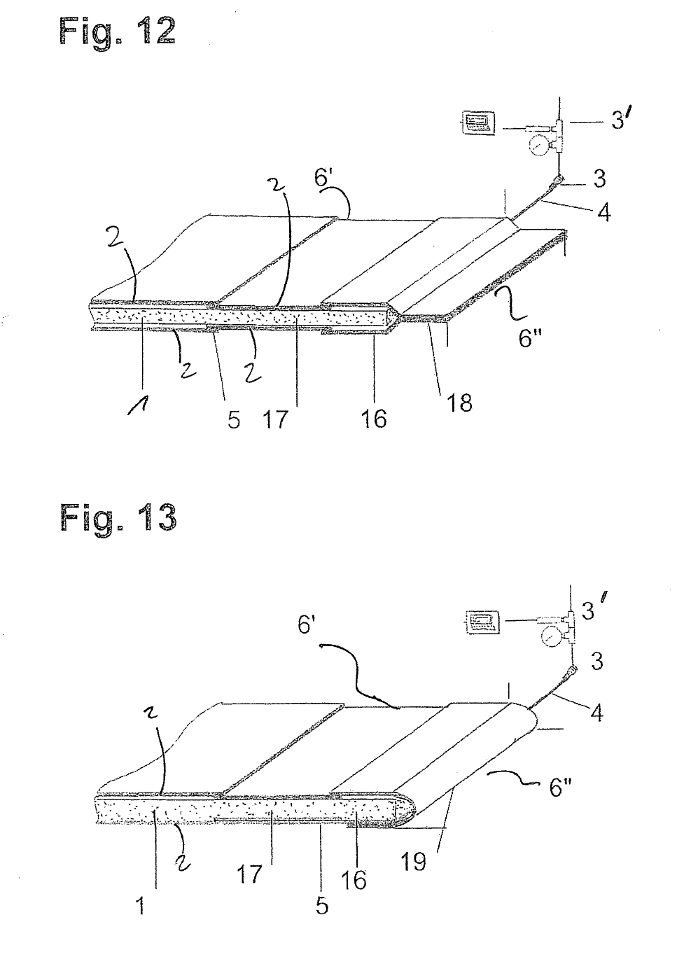

FIG. 12 a perspective view of a cut-open, reusable basic element of the chemical mixture protection device with internal, at least single-ply swellable nonwoven sealing strips against water penetration in the form of vacuum sealing cushions (valve), which in the form of goods sold by the meter in widths up to 12 m and lengths up to 100 m by continuous gas welding covers the basic elements, lying one above the other, all the way around with an aluminum composite foil with an impact strength of 40 N/cm² in tension- and tear-proof fashion with mounting;

FIG. 13 a perspective view of a water protection device, similar to FIG. 12, in subsections in which the basic element of the sealing cushion (valve) is embodied without mounts;

FIG. 14 a perspective view of a water protection device similar to FIG. 12 in subsections, in which the composite foils basic elements are produced on the surface with a high impact-strength and tension- and tear-resistant connection by continuous gas welding;

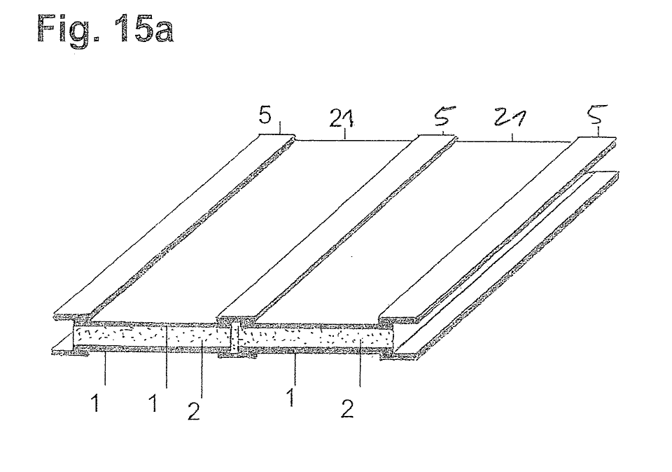

FIG. 15a/15b perspective views of the water protection devices, similar to FIGS. 12, 13 and 14, in subsections, in which the basic elements are lined up with one another, and in the continuous gas welding the basic elements are connected to one another in tensile- and tear-proof fashion by a composite foil strip;

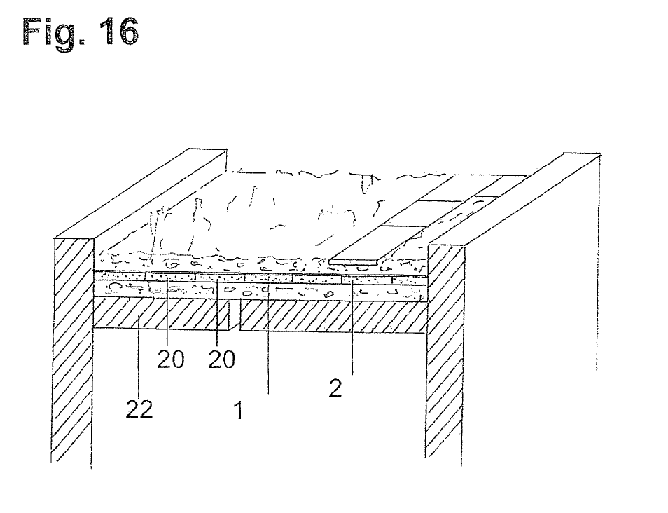

FIG. 16 a perspective view of a water protection device, similar to FIGS. 14 and 15b, in subsections, in which laying composite foil or basic elements with the swellable nonwoven side onto the construction or container, and/or gluing them to the walls, or the composite foil, depending on the expected water column, is weighted and introduced in widths of 140, 300, 600, 900 and 1200 mm and in lengths of up to 100 m;

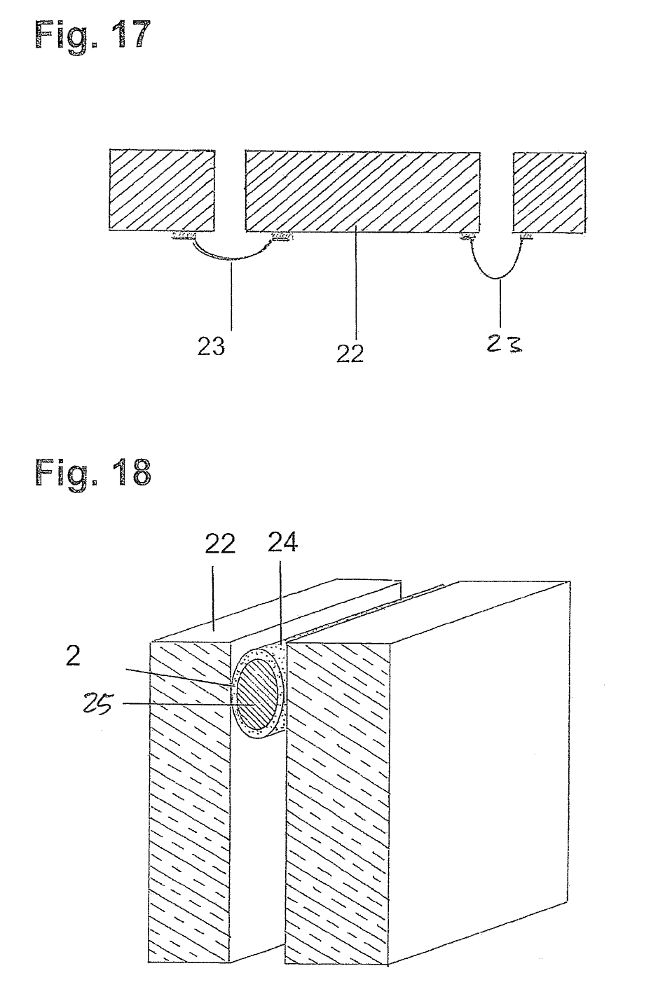

FIG. 17 a cross section of a water protection device in subsystems in which the composite foil is beneath the joint is produced as a water runoff gutter in widths of 140, 300 and 600 mm and lengths up to 500 m;

FIG. 18 a perspective view of a swellable nonwoven-sheathed round cord of PE foam or flexible fireproofing material as goods sold by the meter, which in expansion joints above the joint prevents penetration of seeping water and/or water that is not exerting pressure;

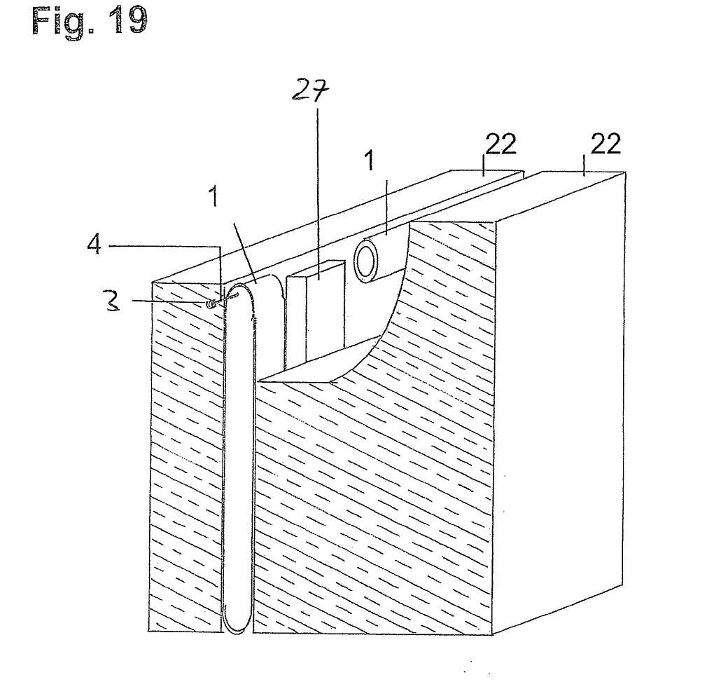

FIG. 19 a perspective view of a water and fire penetration protection device, comprising a swellable nonwoven-sheathed, flexible fire protection strip that individually or in combination with the sealing cushion with a valve prevents seeping water penetration that is located as a water barrier for a water column up to 10 m in expansion joints upstream of the swellable nonwoven-sheathed fire protection strip; in the event of fire >100° C., the sealing cushion and valve collapses with ensuing swelling of the fire protection strip, so that protection from fire penetration is achieved;

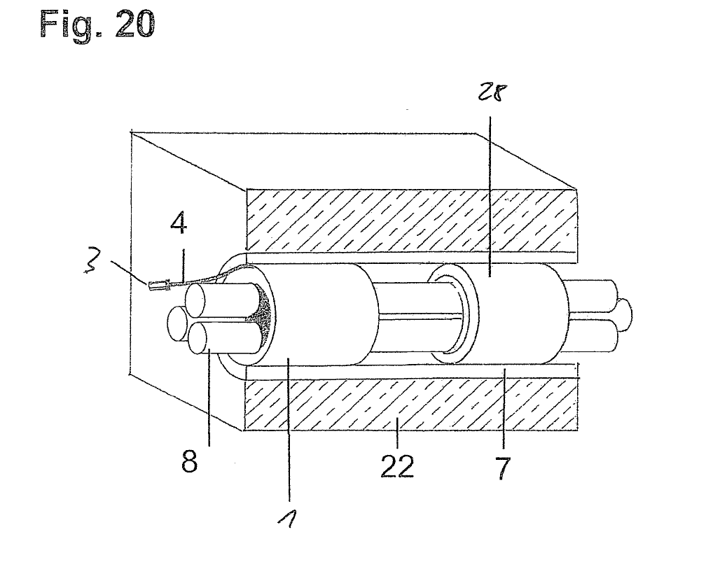

FIG. 20 a perspective view of a water and fire penetration protection device similar to FIG. 19, which is wound in circular fashion about cables and tubes in the cable duct, pipe, and building infeed ducts and lead-throughs that are placed and are sealed off with sealing cushions (valve).

FIG. 1 shows the device comprising a flat-tube cushion 1, coated on both sides on the outside with swellable nonwoven sealing strip 2, with a compressed-air valve 3 connected to a metal, plastic-coated valve extension 4, which is located on a long side 6′ 150 mm to 23 m in length or on the face ends or broad sides 6″ of the flat-tube cushion 1 that are from 10 cm to 60 cm wide and which serves, in a single-ply application, to provide optimal pressure distribution. The embodiment as a flat-tube cushion is attained by production of pressure-tight closures 5 in the longitudinal direction 6′ and on both ends of the composite foil surfaces.

Depending on the field of application, the flat-tube cushion 1 is placed in circular fashion between a masonry perforation or cable duct 7 and a media pipe 8 or multiple media pipe 7 or multiple cable 8. By filling and/or evacuating the device via the compressed-air valve 3 with the metal, plastic-coated valve extension 4 with gaseous or pulverized or liquid fill media 3, the cavities are filled with the swellable nonwoven sealing strip 2. After the filling has been let out of the flat-tube cushion 1, simple dismantling is possible, and the flat-tube cushion 1 can be re-used.

FIG. 1 shows two flat-tube cushions 1 placed one above the other. The swellable nonwoven sealing strip 2 is intended for an external coating. The flat-tube cushion 1 is embodied as a composite film with impact strength and burst pressure resistance. The pressure-tight closure 5 is produced by means of continuous gas welding or hot sealing welding methods.

FIG. 2 shows a cross section of a protection device similar to FIG. 1, which for single-ply, circular use in ducts 7, placed with cables and/or pipes 8, pipes 8 and/or building inlets and lead-throughs 7 with a swellable nonwoven interstice seal 2 with interaction in heat and water of the sealing cushion 1 has a swellable nonwoven sealing star 9 high-frequency welded once longitudinally or sewn or a swellable nonwoven insertion sealing star, which comprises two longitudinal seams and a transverse seam and/or a high-frequency weld.

FIG. 3 shows a perspective view of the four-chamber swellable nonwoven sealing star 9 interstice seal shown in FIG. 2 with interaction in heat and water, produced from at least two swellable nonwoven sealing strips 2 placed one above the other, which are high-frequency welded or sewn centrally in the longitudinal direction.

FIG. 4 shows a similar device as in FIG. 3, in which as a four-chamber swellable nonwoven-insertion sealing star 9, two hot-frequency welds and/or seams can be applied in the longitudinal direction, and one such weld and/or seam in the middle.

FIG. 5 shows a perspective view similar to FIG. 1 with longitudinal or arched expansion joints with use up to 100 m embodied such that the flat-tube cushion 1, or a plurality of flat-tube cushions, are advantageously introduced offset or one above the other, and the flat-tube cushions 1 can be folded from a composite film with impact strength and burst pressure resistance in the longitudinal direction and produced by continuous gas welding as flat-tube cushions 1 even in lengths of up to more than 300 m and widths up to 60 cm.

By filling the flat-tube cushions 1 with gaseous fill media via the compressed-air valve 3, cavities are filled; for monitoring joint movements, temperature changes and leakage points, a simple 2.4 GHz monitoring measuring system is adaptable. After evacuating the filling from the flat-tube cushion 1 via the tire valve 3, dismantling for inspection work and re-use of the flat-tube cushion 1 is possible.

FIG. 6 shows a perspective view of the water protection device shown in FIGS. 1 and 5 in expansion joints or subsections in which the flat-tube cushion 1 by being filled fills up the cavities between the joint flanks 11.

FIG. 7 shows a cross section through FIGS. 1, 5 and 6 embodied such that the flat-tube cushion 1 can be introduced overlapped in an expansion joint of subsections 11 via joint offset locations 12 comprising concrete residues.

FIG. 8 shows a similar cross section as in FIGS. 1, 5, 6 and 7, embodied such that the flat-tube cushion 1, after being filled, can reliably seal off joint offset locations 12 of up to 6 cm over a length of 1 m against water penetration with concrete residues in the expansion joint 11.

FIG. 9 shows a cross section similar to FIG. 8 embodied such that advantageously two sealing cushions 1 are placed one above the other, which can seal off expansion joints 11 against water penetration with a larger than the permissible flat-tube cushion sealing width and joint offset locations 12.

FIG. 10 shows a cross section similar to FIG. 9, embodied such that the flat-tube cushion 1 is shown with a special width of the flat-tube cushion.

FIG. 11 shows a cross section similar to FIGS. 6, 7, 8 and 10 embodied such that the flat-tube cushion 1 can be introduced at a portion into longitudinal expansion joints 11 and rectangular expansion joints 14; the corner areas are equipped with corner, T-shaped and/or cross-joint round modules 15, so that sealing off against water conduction is achieved.

FIG. 12 shows a perspective cross-sectional view of a vacuum flat-tube cushion-valve-basic element 16 with a swellable nonwoven sealing strip inside it, with at least one ply 17 on one side glued to the composite foil 1, having a vacuum/compressed-air valve 3 which is closed with a metal, plastic-coated valve extension 4 having the composite foil 1 with impact strength and resistance to burst pressure, by the hot sealing welding process. The flat-tube cushion-valve-basic element 16 is produced to size all the way around by the continuous gas welding in supplied widths 6″ of up to 12 m and lengths 6′ of up to 100 m with swellable nonwoven sealing strip 17 and overlapping composite foil 1 lying against one another, with tensile strength and pressure resistance because of the continuous gas welding. A plurality of basic elements can be connected to one another in tensile- and pressure-resistant fashion via a detachable base profile section mounting 18 for receiving eyelets, ropes, screws, nails and the like. For purposes of monitoring temperature and tightness of individual basic elements 16, after evacuation of the residual air, vacuum can be applied to each tire valve 3 with a 2.4 GHz or equivalent monitoring measuring system.

FIG. 13 shows a perspective view, similar to FIG. 12, of a flat-tube cushion with a valve and basic element 16 without a base profile section mounting 19; depending on the kinds of use, the vacuum-flat-tube cushion valve-basic elements can be placed in peripheral regions, offset one above the other or side by side, connected nondetachably to one another by the continuous gas weld 5 as an individual basic element 16, but each basic element is monitored on its own via the tire valve 3.

FIG. 15a shows a perspective view of a vacuum flat-tube cushion with a valve 16, similar to FIGS. 12 and 13, in subsections, embodied such that depending on the intended use the swellable nonwoven sealing strip 2 is glued on one side in one or more plies 17 in the joint flank profile section 16; the joint flank profile sections 16, located side by side at 21, are connected to one another with composite film strips 1 by the continuous gas welding method.

FIG. 16 shows a perspective view, similar to FIG. 14, of a water protection device 20 in subsections 22, in which the base profile body 20, located side by side connected to one another 20 by the continuous gas weld 5 are placed or glued 21 with the swellable nonwoven sealing strip side 2 onto the construction.

FIG. 17 shows a cross section through a water runoff gutter 23 comprising a composite foil 1, which is secured underneath and/or above a expansion joint 23 in subsections 22 at least every 2 m along the construction.

FIG. 18 shows a perspective view of a swellable nonwoven round cord water barrier layer device 24 in expansion joints of subsections 22 above the joint, embodied such that depending on the intended use, a PE round cord 25, fire protection strip or fire protection cord is introduced with a swellable nonwoven-sheathed 2 by the high-frequency welding process.

FIG. 19 shows a perspective view, similar to FIG. 18, as a water and fire penetration protection device 27 in expansion joints 22 in combination with a sealing cushion with a valve 1. In the combination, the sealing cushion with the valve serves as a water barrier for a water column of up to 10 m, having the properties that in the event of leakage caused by fire damage, locally tripped temperature and pressure changes can be forwarded to a central control point by a 2.4 GHz monitoring measuring system attached to the tire valve 3, and that the cushion with the valve 3 collapses at >100° C., and the swellable nonwoven-sheathed flexible fire protection strip 27 by swelling of the fire protection mass of the strip 28 achieves a fire penetration protection.

FIG. 20 shows a perspective view, similar to FIG. 19, embodied such that the water and fire penetration protection device 27 is used in a circular application 29 in ducts 7. The sealing cushion with the valve 1 has a similar cross section to the protection device of FIG. 2 in a circular use with cables and/or pipes 8 and/or building inlets and lead-throughs. In addition to the water protection device shown in FIG. 2, immediately downstream of the sealing cushion 1 with the valve there is a fire penetration protection device 28, which is introduced circularly in at least one ply around the cables and/or pipes 8 placed in ducts.

It is also important that the flat-tube cushion is produced with a burst pressure resistance of up to 9 bar, impact strength of up to 40 N/cm², chemical resistance to pH2, pH12, gasoline, diesel, kerosene, paraffin oil, and temperature resistance of from −60° C. to +70° C.

### LIST OF REFERENCE NUMERALS

1 Flat-tube cushion
2 Swellable nonwoven sealing strip
3 Tire valve for filling or evacuation
3′ Monitoring system for vacuum, pressure and temperature
4 Valve extension, metal, plastic-coated
5 Pressure-tight closure
6′ Longitudinal side/longitudinal direction of sealing cushion, cushion length
6″ Transverse side of sealing cushion (face end of cushion width)
7 Cable duct, pipe, building inlet and lead-through
8 Cable or pipe
9 Four-chamber swellable nonwoven sealing star, high-frequency welded or sewn
10 High-frequency weld
11 Joint flank
12 Joint offset location
14 Expansion joint with rectangular expansion joint course
15 Round module for corner joint, T joint and/or cross joint
16 Basic element of the vacuum flat-tube cushion (valve)
17 Swellable nonwoven sealing strip, located inside, having at least one ply
18 Soluble base profile section mounting for receiving eyelets, ropes, screws
19 Swellable nonwoven sealing strip without soluble base profile section mounting
20 Water mixture protection device
21 Swellable nonwoven sealing strip, having gluable elastic adhesives on masonry structures and/or metal/plastic containers
22 Subsections
23 Water runoff gutter below or above the joint
24 Swellable nonwoven round cord, water barrier layer
25 PE round cord or fireproof cord
27 Water-fire penetration protection device/strip in expansion joints or fireproof strip, flexible
28 Fireproof strip, flexible

1. A device for protection against water ingress and fire penetration into interstices and into cavities through expansion joints (11, 12, 14) in subsections, cable ducts (7, 8), and building lead-throughs (7, 8) that are occupied by cables and/or pipes and serve, as needed, as fire protection or leak protection devices (20), landfills, tank systems, transport and/or safety containers in the sea,
characterized in that
the device comprises a flat-tube cushion (1), fixed in length (6′) and width (6″), which is equipped on the outsides with a swellable nonwoven sealing strip (2), and that the leakage or protection flat-tube cushion (1) is provided in the interior with at least one swellable nonwoven sealing strip (17) that has high-tensile-strength closures (18) on the long side (6′) and the transverse side (6″) and is filled or evacuated (3) via at least one plastic-coated, metal compressed-air valve (3) with valve extension (4) and as needed can be equipped with a radio monitoring or control system (3′).

2. The device of claim 1,
characterized in that
a single-ply, circular or longitudinal and/or longitudinal, two-play arrangement of the flat-tube cushion (1) is provided, wherein the valve (3) is joined to the flat-tube cushion (1) in the hot-sealing welding process by means of a valve extension (4) for a total leakage rate of 5.5 mbar/s.

3. The device of claim 1,
characterized in that
the flat-tube cushion (1) is located in the area of use as a single element, horizontal, vertical, full-circular or semicircular in the pipe circumference or the expansion joint segment, and the compressed-air valve (3) is located at least on one end (3) of the flat-tube cushion (1) and by means of the metal extension (4), a special valve (3) that is flexible in all directions can be produced.

4. The device of claim 1,
characterized in that
on its inside or outside, in the longitudinal or transverse direction, the device additionally has an elastic, not permanently adhesive swellable nonwoven sealing strip (2), which after water contact rapidly swells, having an area weight of 480 g/m².

5. The device of claim 1,
characterized in that
upon sealing of cable duct pipes (7) penetrated by cables (8) and/or cable pipes (8), in the vicinity of the contact points of cable duct pipes (8) and/or cable duct pipes (7), a wrapping comprising a swellable nonwoven sealing strip (2) with or without a backing film is used, and in the nip, filling elements or swellable nonwoven sealing stars (9) are located, which are produced from sealing strip material (2).

6. The device of claim 5,
characterized in that
the swellable nonwoven sealing star for insertion between two and more cables is produced from two swellable nonwoven sealing strips (2) placed one over the other with two longitudinal seams and a transverse seam (10) and/or two swellable nonwoven sealing strips placed one over the other, connected by a ≧5 mm wide longitudinal weld seam (9.

7. The device of claim 1,
characterized in that
the flat-tube cushion (1) in combination with a water-fire penetration-protection device for longitudinal use in expansion joints (27) or circular use in ducts (7) occupied by cables and/or pipes (8) is equipped as a compressed-water-tight barrier layer, which is produced with a possible monitoring measuring system (3) and a flexible fireproof strip (28), sheathed with swellable nonwoven sealing strip (2) in the high-frequency welding process (9), is produced as a fire penetration protection (27).

8. The device of claim 1,
characterized in that
the flat-tube cushion (1) is filled with gaseous, pulverized or liquid media, swellable nonwoven sealing strips (2, 17), and/or magnetic or lead strips.

9. The device of claim 1,
characterized in that
the flat-tube cushion (1) is produced, adapted in length to the circumference of the duct (7) and in the length of the expansion joint (6′), and in the width of 135, 285 or 420 mm (6″).

10. The device of claim 1,
characterized in that
the water leakage and/or protection flat-tube cushion device (1, 16, 20, 21) is produced from one or more basic elements, placed over one another or next to one another, in the form of goods sold by the meter in widths of up to 12 m and in lengths of up to 100 m by continuous gas welding to one another in high-tensile-strength and pressureproof form and is connected on one side to a swellable nonwoven sealing strip (2) by means of elastic adhesive.

11. The device of claim 1,
characterized in that
the water leakage protection device or the flat-tube cushion (16, 20, 21) is produced preferably in the interior with one or more swellable nonwoven sealing strip layers (17), glued to one another, of 480 g/m².

12. The device of claim 1,
characterized in that
the swellable nonwoven sealing strip (2, 17) of 480 g/m² is produced from a mechanically hardened PP nonwoven with water-absorbent, rapidly water-swelling polymer.

13. The device of claim 1,
characterized in that
the flat-tube cushion (1, 6′, 6″, 16, 20, 21) is produced from a folded strip or tube which depending on the area of use comprises thermoplastic, elastomers, and/or highly inflammable thermoplastic-elastomer mixtures, and these substances have metal and/or metal-free inlays.

14. The device of claim 1,
characterized in that
a strip (1′″) of the flat-tube cushion (1, 6′, 6″, 16, 20, 21) is produced at least from a five-ply thermoplastic composite film (1′″) having the following structure

| | |
|---|---|
| 150-250 μm PE | 150-250 μm PE |
| 15-30 μm PET | 15-30 μm PET |
| 9-23 μm ALUMINUM | 9-23 μm LEAD |
| 15-30 μm PET | 15-30 μm PET |
| 150-250 μm PE | 150-250 μm PE. |

15. The device of claim 1,
characterized in that
the flat-tube cushion with a furnished valve closure cap has a total leakage rate of L= . . . 5.5≦6.2×10-8 mbarl/s, corresponds to 2.7 mbarl/year.
